(19) United States
(12) Patent Application Publication
(10) Pub. No.: US 2009/0315981 A1
(43) Pub. Date: Dec. 24, 2009

(54) IMAGE PROCESSING METHOD AND APPARATUS

(75) Inventors: Kil-soo JUNG, Osan-si (KR); Hyun-kwon CHUNG, Seoul (KR); Dae-jong LEE, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/490,582

(22) Filed: Jun. 24, 2009

Related U.S. Application Data
(60) Provisional application No. 61/075,184, filed on Jun. 24, 2008.

(30) Foreign Application Priority Data
Sep. 24, 2008 (KR) 10-2008-0093867
Sep. 30, 2008 (KR) 10-2008-0096024

(51) Int. Cl. H04N 13/00; G06K 9/00

(52) U.S. Cl. 348/43; 382/154; 348/E13.001; 386/E05.064

(57) ABSTRACT

An image processing method and an image processing apparatus, the image processing method including: extracting background depth information and object depth information from meta data with respect to video data; creating a depth map for a background of a frame of the video data using the background depth information; and creating a depth map for an object of the frame of the video data by using the object depth information, wherein the object is a normal object that contacts the background or a highlighted object that does not contact the background.

### CROSS-REFERENCE TO RELATED APPLICATIONS

This application claims the benefit of U.S. Provisional Patent Application No. 61/075,184, filed on Jun. 24, 2008 in the U.S. Patent and Trademark Office, and the benefit of Korean Patent Application No. 10-2008-0093867, filed on Sep. 24, 2008, and Korean Patent Application No. 10-2008-0096024, filed on Sep. 30, 2008 in the Korean Intellectual Property Office, the disclosures of which are incorporated herein in their entirety by reference.

### BACKGROUND OF THE INVENTION

1. Field of the Invention

Aspects of the present invention relate to an image processing method and apparatus, and more particularly, to an image processing method and apparatus to generate a depth map for a normal object or a highlighted object by using background depth information extracted from meta data with respect to video data.

2. Description of the Related Art

Three-dimensional (3D) image techniques have become widely spread due to the development of digital technology. The 3D image techniques give a two-dimensional (2D) image depth information to represent a more realistic image. The human eyes are separated from each other by a predetermined distance in the horizontal direction. Thus, the left eye and the right eye see different 2D images, which is called disparity. The human brain combines the two different 2D images seen by the left and right eyes to create a 3D image having depth and reality. The 3D image techniques include a technique of generating a 3D image from video data and a technique of converting video data corresponding to a 2D image into a 3D image. Studies on both the techniques are being performed.

### SUMMARY OF THE INVENTION

Aspects of the present invention provide an image processing method and apparatus to generate a depth map for an object using background depth information.

According to an aspect of the present invention, there is provided an image processing method including: extracting background depth information and object depth information from meta data with respect to video data; creating a depth map for a background of a frame of the video data by using the background depth information; and creating a depth map for an object of the frame of the video data by using the object depth information, wherein the object is a normal object that contacts the background or a highlighted object that does not contact the background.

According to an aspect of the present invention, the creating of the depth map for the object may include extracting object region information to identify a region of the object from the object depth information.

According to an aspect of the present invention, the object region information may include coordinates to identify the region of the object or a mask on which the shape of the object is indicated.

According to an aspect of the present invention, the creating of the depth map for the background may include creating the depth map for the background by using coordinates of the background, depth values of the background corresponding to the coordinates, and a panel position value representing a depth value of an output screen for the video data, wherein the coordinates of the background, the depth values of the background, and the panel position value are included in the background depth information.

According to an aspect of the present invention, if the object is a normal object and the object region information is coordinates indicating the region of the object, the creating of the depth map for the object may include: detecting coordinates identical to the coordinates indicating the region of the normal object from among coordinates of the background; and creating a depth map for the normal object by using the background depth values corresponding to the detected coordinates as the depth values for the region of the normal object.

According to an aspect of the present invention, if the object is a normal object and the object region information is a mask on which a shape of the object is indicated, the creating of the depth map for the object may include: extracting reference information representing coordinates identical to the coordinates indicating the region of the normal object from among the coordinates of the background, from the object depth information; and creating a depth map for the normal object by using the background depth values corresponding to the identical coordinates as depth values for the region of the normal object, by using the reference information.

According to an aspect of the present invention, if the object is a highlighted object, the creating of the depth map for the object may include: creating a depth map for the highlighted object by using, as the depth value of the region of the highlighted object, a value obtained using an offset value included in the object depth information and the panel position value.

According to an aspect of the present invention, the meta data may include shot information to classify frames of the video data into units of shots, and the image processing method may further include determining, based on the shot information, whether a current frame is a frame classified into a new shot; and the extracting of the background depth information may include, when the current frame corresponds to the frame classified as the new shot, extracting background depth information to be applied to the frame classified into the new shot.

According to an aspect of the present invention, the shot information may include output time information of an initially output frame from among frames classified into a single shot and output time information of a finally output frame from among the frames, and the operation of extracting the background depth information may include determining, based on the output time information of the initially output frame and/or the finally output frame, whether the current frame corresponds to the frame classified into the new shot.

According to an aspect of the present invention, the image processing method may further include extracting information on an output period of time of frames including the normal object from among the frames classified into the shot from the meta data.

The image processing method may further include reading the meta data from a disc on which the video data is recorded or downloading the meta data from a server via a communication network.

According to an aspect of the present invention, the meta data may include identification information to identify the video data, and the identification information may include a disc identifier to identify the disc on which the video data is recorded and a title identifier to identify which one of titles included in the disc includes the video data.

According to another aspect of the present invention, there is provided an image processing apparatus including: a meta data analyzer to extract background depth information and object depth information from meta data with respect to video data and to analyze the meta data; and a depth map generator to create a depth map for a background of a frame of the video data by using the background depth information and to create a depth map for an object of the frame of the video data by using the object depth information, wherein the object is a normal object that contacts the background or a highlighted object that does not contact the background.

According to yet another aspect of the present invention, there is provided a computer readable information storage medium storing meta data to convert video data into a three-dimensional (3D) image, wherein: the meta data includes background depth information and object depth information; the background depth information includes coordinates of a background of a frame of the video data, depth values of the background corresponding to the coordinates, and a panel position value representing a depth value of an output screen for the video data; the object depth information represents the a of the object of a frame of the video data as coordinates or a mask on which a shape of the object is indicated; an image processing apparatus generates a depth map for the background and a depth map for the object by using the background depth information and the object depth information; and the object is a normal object that contacts the background or a highlighted object that does not contact the background.

According to still another aspect of the present invention, there is provided a computer readable information storage medium storing a program to execute an image processing method, the method including: extracting background depth information and object depth information from meta data with respect to video data; creating a depth map for a background of a frame of the video data by using the background depth information; and creating a depth map for an object of the frame of the video data by using the object depth information, wherein the object is a normal object that contacts the background or a highlighted object that does not contact the background.

According to another aspect of the present invention, there is provided a meta data transmitting method performed in a server connected to an image processing apparatus, the method including: receiving, by the server, a request for meta data to convert video data into a three-dimensional (3D) image from the image processing apparatus; and transmitting, by the server, the meta data to the image processing apparatus in response to the request, wherein: the meta data includes background depth information and object depth information; the background depth information includes coordinates of a background of a frame of the video data, depth values of the background corresponding to the coordinates, and a panel position value representing a depth value of an output screen for the video data; the object depth information includes coordinates to identify a region of an object of the frame of the video data or a mask on which a shape of the object is indicated; and the object includes is a normal object that contacts the background or a highlighted object that does not contact the background.

According to another aspect of the present invention, there is provided a server connected to an image processing apparatus, the server including: a transceiver to receive a request for meta data to convert video data into a three-dimensional (3D) image from the image processing apparatus and to transmit the meta data to the image processing apparatus in response to the request; and a meta data storage to store the meta data, wherein: the meta data includes background depth information and object depth information; the background depth information includes coordinates of a background of a frame of the video data, depth values of the background corresponding to the coordinates, and a panel position value representing a depth value of an output screen for the video data; the object depth information includes coordinates to identify a region of an object of the frame of the video data or a mask on which a shape of the object is indicated; and the object is a normal object that contacts the background or a highlighted object that does not contact the background.

According to yet another aspect of the present invention, there is provided an image processing method of an image processing apparatus, the image processing method including: extracting background depth information and object depth information from meta data with respect to video data; creating, by the image processing apparatus, a depth map for a background of a frame of the video data by using the background depth information; and creating, by the image processing apparatus, a depth map for an object of the frame of the video data according to whether the object is a normal object or a highlighted object by using the object depth information, wherein the normal object contacts the background and the highlighted object does not contact the background.

According to still another aspect of the present invention, there is provided an image processing method of an image processing apparatus, the image processing method including: extracting object depth information from meta data with respect to video data; and creating, by the image processing apparatus, a depth map for an object of a frame of the video data according to whether the object is a normal object or a highlighted object by using the object depth information, wherein the normal object contacts a background of the frame and the highlighted object does not contact the background.

According to another aspect of the present invention, there is provided a computer-readable recording medium implemented by an image processing apparatus, the computer-readable recording medium including: meta data regarding video data and used by the image processing apparatus to convert the video data into a three-dimensional (3D) image, wherein: the meta data includes background depth information and object depth information; the background depth information includes coordinates of a background of a frame of the video data, depth values of the background corresponding to the coordinates, and a panel position value representing a depth value of an output screen for the video data; the object depth information represents a region of an object on the frame and includes an offset value that indicates to the image processing apparatus when the object is a normal object that contacts the background or is a highlighted object that does not contact the background; the background depth information and the object depth information are respectively used by the image processing apparatus to generate a depth map for the background and a depth map for the object; and the image processing apparatus adds the offset value to the panel position value to generate the depth map for the highlighted object.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates meta data with respect to video data according to an embodiment of the present invention;

FIGS. 2A and 2B are diagrams to explain depth information used in an embodiment of the present invention;

FIGS. 3A and 3B are diagrams to explain generation of a depth map using meta data illustrated in FIG. 1;

FIG. 4 is a schematic diagram illustrating an image processing system to carry out an image processing method according to an embodiment of the present invention;

FIG. 5 is a block diagram of a depth map generator illustrated in FIG. 4; and

FIG. 6 is a flowchart illustrating a depth map generating method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

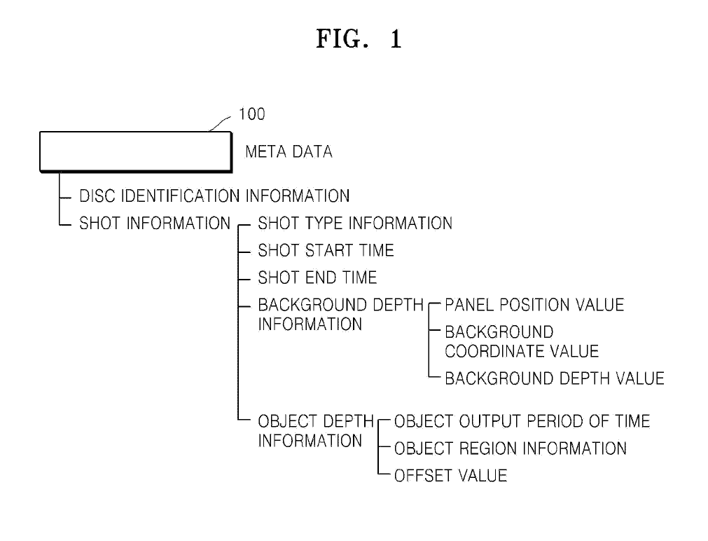

FIG. 1 illustrates meta data 100 with respect to video data, according to an embodiment of the present invention. The meta data 100 includes information on the video data. That is, the meta data includes disc identification information to identify the video data. Specifically, the disc identification information indicates which video data the meta data 100 is associated with. The disc identification information includes a disc identifier to identify a disc on which the video data has been recorded, and a title identifier representing a title, from among a plurality of titles recorded on the disc identified by the disc identifier, that the video data corresponds to. However, it is understood that the disc identifier can include an address on a remote storage medium, such as on a server, where the video data is stored remotely.

The video data includes a series of frames and, thus, the meta data 100 includes information on the frames. The information on the frames includes information to classify the frames according to a predetermined standard. When a bundle of similar frames is referred to as a unit, the frames of the video data may be classified into a plurality of units. In the shown embodiment, the meta data 100 includes information to classify the frames of the video data into predetermined units. Specifically, when frames have similar compositions and thus the composition of a current frame can be estimated using a previous frame, a series of frames having similar compositions are referred to as a single shot. That is, the meta data 100 includes information to classify the frames of the video data into shots. Hereinafter, information about shots, which is included in meta data, is referred to as shot information. When compositions of frames are remarkably different such that the composition of a current frame is different from the composition of a previous frame, the current frame and the previous frame are classified into different shots.

The shot information indicates a location where a predetermined shot starts and a location where the predetermined shot ends. Specifically, the locations may be represented as time information or frame numbers. In FIG. 1, a shot start time and a shot end time are included in the shot information. The shot start time corresponds to an output time of an initially output frame from among frames classified into the predetermined shot, and the shot end time corresponds to an output time of a finally output frame from among the frames. In some cases, the shot information may include the frame number of the initially output frame from among the frames included in the predetermined shot and the frame number of the finally output frame from among the frames, instead of (or in addition to) including the shot start time and the shot end time. While not required, one of the shot end and start times or frame can be replaced by a number of frames or a duration of time for the shot relative to a start or end time or frame.

The meta data 100 further includes shot type information on frames classified into a single shot. The shot type information represents whether frames belonging to each shot are to be output as a 2D image or a 3D image. When the shot type information represents that frames belonging to a predetermined shot are to be output as a 3D image, the meta data 100 further includes information used to convert the frames into the 3D image. In particular, to apply a 3D effect to a 2D image, the 2D image is given depth. An image projected onto a screen is formed in two eyes of a person when the person watches the screen. Here, a distance between images formed in the two eyes is referred to as a parallax. Parallaxes are classified into a positive parallax, a zero parallax, and a negative parallax. The positive parallax is a parallax when the image appears to be formed behind the screen, and the parallax is smaller than or equal to a distance between eyes. In this case, as the parallax increases, a stereoscopic effect that it seems as if the image is placed deeper than the screen is obtained.

When the image appears to be formed on the plane of the screen two-dimensionally, the parallax becomes zero. In this case, a viewer cannot feel the stereoscopic effect because the image appears to be formed on the plane of the screen. The negative parallax is a parallax when the image appears to be formed in front of the screen and occurs when the focus of each of a viewer's eyes intersects each other, to thereby produce a stereoscopic effect that seems as if a displayed object protrudes from the plane of the screen.

According to aspects of the present invention, a depth map for a frame is generated to give a depth to the frame in order to convert a 2D image to a 3D image. To achieve this, the meta data 100 includes depth information to give the depth to the frame. The depth information is used to give the depth to the frame to convert a 2D image corresponding to the frame into a 3D image, and is classified into background depth information and object depth information. The background depth information denotes information to generate a depth map for a background, and the object depth information denotes information to generate a depth map for an object. Although the depth information is included in the shot information in FIG. 1, it is understood that aspects of the present invention are not limited thereto. For example, according to other aspects, the depth information may be separated from the shot information and be included directly in the meta data 100.

An image of a single frame includes a background image and an object image. The background depth information is used to give a depth to the background image. Giving a depth to the background image denotes giving a depth to the composition of the background, such as the position and shape of the background. Frames may have various compositions, and thus background depth information for each shot included in the meta data 100 may include information on a composition type of the background of a frame to identify the background composition from a plurality of predetermined background compositions. Instead of or in addition to the composition type of the background, the shown background depth information further includes background coordinate values, background depth values corresponding to the background coordinate values, and a panel position value that represents a depth value of the screen on which an image is output. In detail, the background coordinate values correspond to the values of coordinate points of a background included in a frame of a 2D image. A depth value represents a degree of depth to be given to an image, and the meta data includes a depth value to be given to a coordinate value of the frame of a 2D image. A panel position represents the location of a screen on which an image is formed.

An object denotes an object that remains after a background is removed from an image. For example, the object may be a person or building that stands on the background or an object that floats in the air. According to aspects of the present invention, objects are classified into a normal object and a highlighted object according to how depth values are to be given to objects when depth maps for the objects are generated. The normal object is an object that contacts a background. Thus, the depth value of the normal object corresponds to the depth value of a portion of the background that the normal object contacts. An object that floats in the air without touching the background is referred to as the highlighted object. The highlighted object has a depth value that allows the highlighted object to appear to protrude by a predetermined value from the screen toward a viewer or a depth value that allows the highlighted object to appear to sink behind the screen. Thus, the depth value of the highlighted object is obtained by adding or subtracting the predetermined value to or from the depth value of the screen. Hereinafter, the predetermined value is referred to as an offset value.

The object depth information includes an object output time and object region information to identify an object region. The object output time corresponds to a time when frames having an object among the frames classified into a predetermined shot are output. In some cases, the object depth information may include, instead of (or in addition to) the object output time, the frame numbers of one or more of the frames having the object (for example, the frame numbers of an initially output frame and a finally output frame from among all of the frames having the object). The object region information identifies an object region within a frame, and may correspond to the coordinates of pixels corresponding to the object region from among a plurality of pixels that constitute the frame. In some cases, a mask on which the object region is indicated may be used as the object region information. In this case, one sheet of mask is used for each object.

In some cases, color information may be used as the object region information. The color information represents the color of an object, and may be used to distinguish the object from a background. If the object region information includes the color information, an image processing apparatus (not shown) may ascertain from the color information that the color of the object has a predetermined color range (for example, a color range from dark yellow to light yellow), and detect pixels having RGB values corresponding to this predetermined color range from a frame to thereby find an object region. Furthermore, in some cases, the object region information may include both information representing the object region as coordinates or as a mask and color information representing the object region as a color. In this case, the image processing apparatus may identify the object region within the frame on which the object appears by using the color information the coordinates or the mask in order to increase the accuracy of identification of the object region.

If an object is a normal object and object region information is represented as a mask, although not shown in FIG. 1, object depth information may further include reference information. The reference information denotes information about coordinates identical to coordinates representing the region of a normal object from among the background coordinates included in the background depth information. As described above, the normal object is an object that contacts the background. Thus, the normal object has, as its depth value, a depth of a portion of the background that the normal object touches. However, if the object region information is not given as coordinates but as a mask, the portion of the object that contacts the background cannot be recognized therefrom. Thus, information indicating a place where the object contacts the background is used. This information is the reference information.

If an object is a highlighted object, the depth value of the highlighted object is given as a sum of the panel position value and an offset value or a difference therebetween. Thus, while not required in all aspects, the object depth information further includes information about the offset value as shown.

Although not shown in FIG. 1, the object depth information may further include effect information. If an object is a highlighted object, the effect information is used to give a stereoscopic effect to the highlighted object, because a user cannot feel a 3D effect if all of the pixels corresponding to the region of the highlighted object have identical depth values. According to the effect information, the depth value of the highlighted object is adjusted using a predetermined depth map. For example, if a highlighted object “balloon” is desired to be displayed, since the “balloon” has a spherical shape, it is natural that a user feels that a front side of the balloon is closer to the user than lateral sides thereof when seeing the balloon. To achieve this, depth values may be respectively given to pixels corresponding to the balloon. However, in this case, the size of the metal data 100 increases, and thus one of depth maps having several predetermined compositions may be applied to the region of the highlighted object so that the highlighted object can have a stereoscopic depth value. That is, the image processing apparatus may select a specific depth map from among depth maps pre-defined therein and apply the selected specific depth map to a depth map for the object by using the effect information. For example, the image processing apparatus selects a semi-hemispherical depth map and applies the selected semi-hemispherical depth map to the depth map for the balloon by using the effect information so as to control the depth map for the balloon. This operation is referred to as filtering. Thus, the balloon can have a more stereoscopic depth value, while the size of the meta data does not increase.

According to the above-described embodiment of the present invention, information to convert video data corresponding to a 2D image into a 3D image is included in the meta data 100, and the meta data 100 includes the background depth information and the object depth information. While not required in all aspects, the meta data 100 may further include information to indicate whether an object is a normal object or a highlighted object. In the present invention, the offset value exists only for the highlighted object, but not for the normal object. Thus, if the offset value exists in the metadata 100, the offset value is for the highlighted object.

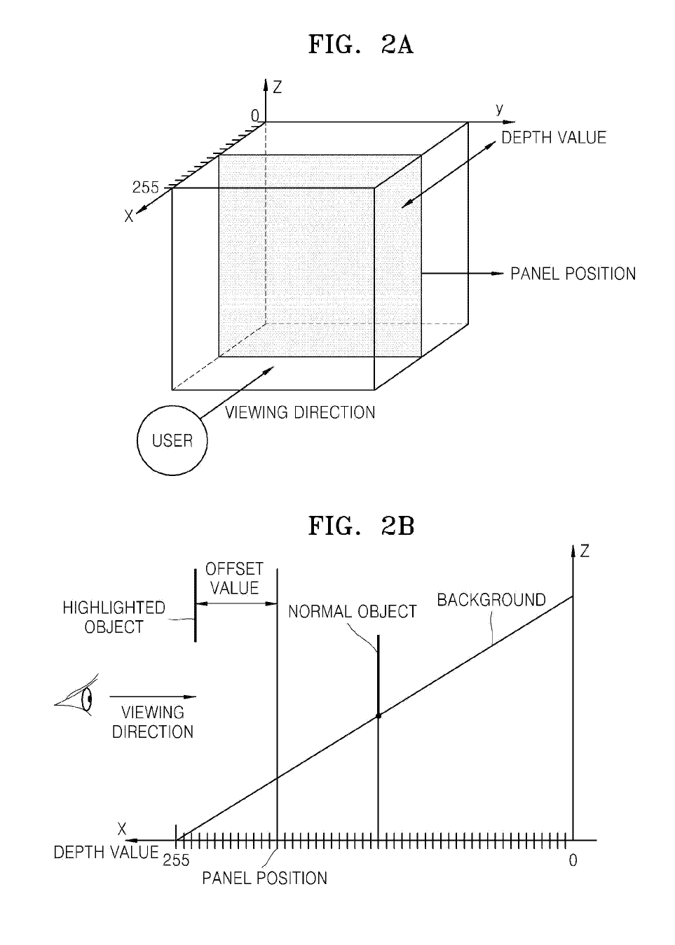

FIGS. 2A and 2B are diagrams to explain depth information used in an embodiment of the present invention. FIG. 2A is a diagram to explain depth given to an image and FIG. 2B is a diagram to explain depth given to the image when the image is viewed from the lateral side of a screen on which the image is projected. As described above, aspects of the present invention give depth to a 2D frame by using depth information. Referring to FIGS. 2A and 2B, an X-axis direction parallel to a direction in which a user watches the screen corresponds to a depth value of the frame. The depth value represents a degree of the depth of the image and may be one of 256 values (i.e., 0 through 255) in an embodiment of the present invention. The image becomes deeper and appears farther from the viewer as the depth value decreases and approximates zero. Conversely, the image appears closer to the viewer as the depth value increases towards 255.

A panel position corresponds to a position of the screen on which the image is formed, and a panel position value corresponds to the depth value of an image when parallax is zero (i.e., when the image appears to be formed on the surface of the screen). As illustrated in FIGS. 2A and 2B, the panel position value may have one of the depth values of 0 through 255. When the panel position value is 255, an image included in the frame has a depth value equal to or smaller than that of the screen, and thus the image appears to be formed far away from the viewer (i.e., on or behind the screen). This means that the image corresponding to the frame has a zero or positive parallax. When the panel position value is zero, the image corresponding to the frame has a depth value equal to or greater than that of the screen, and thus the image appears to be formed on or in front of the screen. This means that the image corresponding to the frame has a zero or negative parallax.

FIG. 2B illustrates depth values of a normal object, a highlighted object, and a background. Since the normal object contacts the background, as illustrated in FIG. 2B, the depth value of the normal object is identical to a depth value of the background at a position where the background contacts the object. Also, as illustrated in FIG. 2B, the highlighted object has a depth value corresponding to a sum of a panel position value and an offset value. Although the highlighted object has a constant depth value in a vertical direction in FIG. 2B, if a depth map is applied to the highlighted object by using effect information, the depth value of the highlighted object may vary in the vertical direction. In FIG. 2B, the highlighted object has a depth value greater than the panel position value, such that a viewer recognizes as if the highlighted object protrudes out of the screen, though it is understood that aspects of the present invention are not limited thereto. For example, the highlighted object may have a depth value less than the panel position value, such that the viewer recognizes as if the highlighted object is behind the screen.

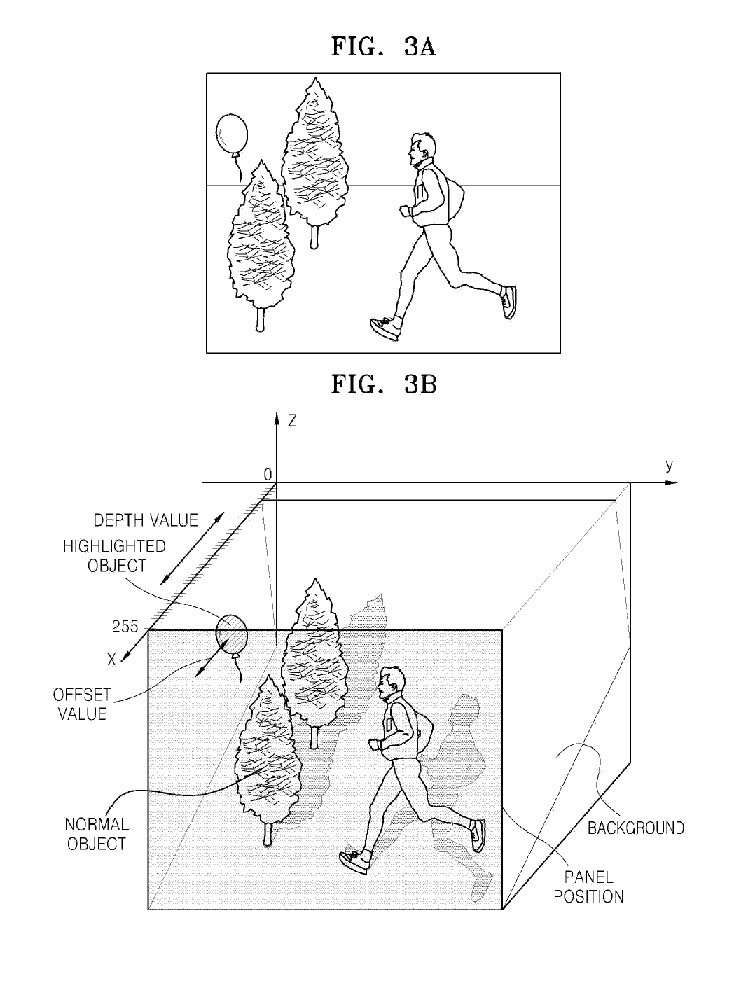

FIGS. 3A and 3B are diagrams to explain generation of a depth map by using the meta data 100 illustrated in FIG. 1. FIG. 3A illustrates a 2D image and FIG. 3B is a diagram to explain a depth map created by giving depth values to the 2D image illustrated in FIG. 3A. According to aspects of the present invention, an image processing apparatus (not shown) divides a frame into a background and an object and generates background depth information for the background and object depth information for the object.

Referring to FIG. 3A, the frame of the 2D image includes a background including the sky and the ground and an object including two trees, a person, and a balloon. The image processing apparatus extracts the background depth information from the meta data 100. As illustrated in FIG. 3A, the frame has a composition in which the boundary between the sky and the ground (i.e., the horizon) is deepest (i.e., has a lowest depth value). The image processing apparatus extracts information about a composition type to be applied to the frame illustrated in FIG. 3A from the background depth information included in the meta data 100. The image processing apparatus gives depth values to the background by using the composition type information and/or the background coordinate values, depth value information, and panel position value information, thereby creating a depth map for the background, as illustrated in FIG. 3B.

As illustrated in FIG. 3B, the depth value of the panel position is 255. Since the panel position has the largest depth value, a stereoscopic effect that seems as if the frame image is entirely deeper than a screen on which the image is displayed is produced. In FIG. 3B, the horizon is located farthest from a viewer because it has a depth value of zero. The lowermost part of the ground has a depth value of 255, and thus an image corresponding to the lowermost part of the ground appears to be formed closest to the viewer.

The image processing apparatus identifies the region of the object from the frame by using the object region information. As described above, the object region information may represent the region of the object as coordinates or as a mask on which the outline (i.e., the shape) of the object is indicated. The frame illustrated in FIG. 3A includes the two trees, the person, and the balloon other than the sky and the ground. The two trees and the person correspond to normal objects because they touch the ground. The balloon corresponds to a highlighted object because the balloon floats in the air without touching the ground (i.e., the background). The image processing apparatus ascertains positions where the normal objects meet the background and extracts background depth values corresponding to coordinate values of the positions where the normal objects meet the background. The image processing apparatus gives the extracted depth values to the normal objects so that the extracted depth values serve as the depth values of the normal objects.

When there are multiple positions where a normal object meets a background, the image processing apparatus extracts depth values of the background respectively corresponding to a plurality of coordinates of the positions and applies the extracted depth values to vertical components of the normal objects, which touch the positions. As illustrated in FIG. 3B, the two trees and the person have, for the vertical components of the normal object, the same depth values as those of positions where the two trees and the person touch the ground, respectively. Thus, a stereoscopic effect that seems as if the normal objects stand on the background at the positions where the objects meet the background results.

Moreover, the image processing apparatus creates a depth map by using a value obtained using the panel position value and the offset information as the depth value of the highlighted object identified using the object region information. The image processing apparatus may apply an identical depth value to the entire region of the highlighted object. However, it is understood that aspects of the present invention are not limited thereto. For example, as described above, the image processing apparatus may allow pixels corresponding to the highlighted object region to have different depth values by using the effect information. Since the highlighted object “balloon” has a spherical shape in FIG. 3B, the image processing apparatus may apply a semi-hemispherical depth map to the highlighted object “balloon” by using the effect information so that a 3D effect can be given to the balloon.

According to the above-described embodiment of the present invention, a depth value of the background at a position where a normal object touches the background is used as the depth value of the normal object, and a value obtained using a panel position value and an offset value is used as the depth value of a highlighted object, thereby creating depth maps for the objects.

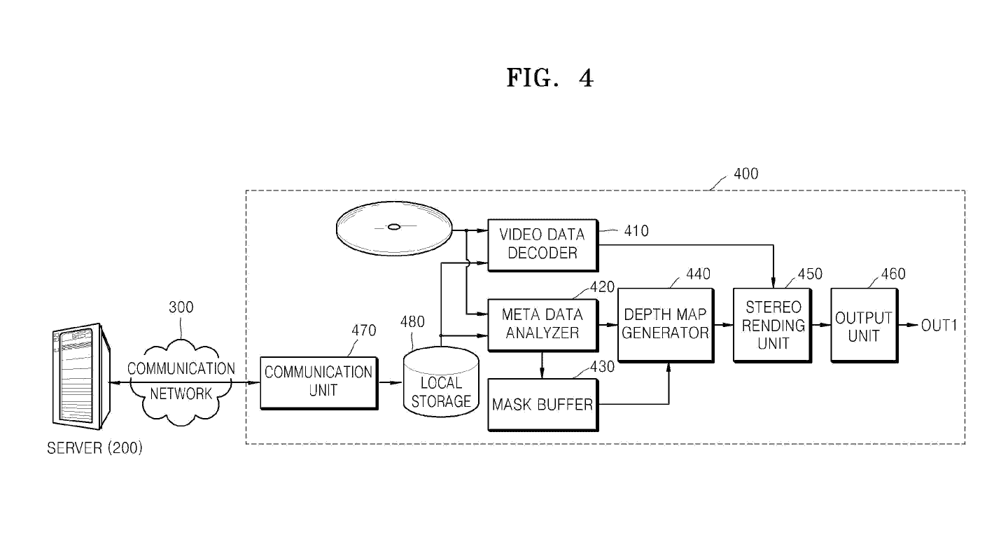

FIG. 4 is a schematic diagram illustrating an image processing system to carry out an image processing method according to an embodiment of the present invention. Referring to FIG. 4, the image processing system includes an image processing apparatus 400, a server 200, and a communication network 300. The image processing apparatus 400 is connected to the server 200 through the communication network 300. The communication network 300 includes a wired and/or wireless communication network. However, it is understood that aspects of the present invention are not limited thereto. For example, according to other aspects, the image processing apparatus 400 may be directly connected to the server 200 via a wired and/or wireless connection (such as a universal serial bus connection, a Bluetooth connection, an infrared connection, etc.). Furthermore, in other aspects, the image processing apparatus 400 may not be connected, at all, to the server 200.

The image processing apparatus 400 includes a video data decoder 410, a meta data analyzer 420, a mask buffer 430, a depth map generator 440, a stereo rendering unit 450, a communication unit 470, a local storage 480, and an output unit 460 to display a 3D image created in a 3D format on a screen. However, it is understood that in other embodiments, the image processing apparatus 400 does not include the output unit 460 and/or is connected to an external output unit or a receiving unit through which a user sees the screen, such as goggles, through wired and/or wireless protocols. The image processing apparatus 400 may be a television, a computer, a mobile device, a set-top box, a gaming system, etc. The output unit 460 may be a cathode ray tube display device, a liquid crystal display device, a plasma display device, an organic light emitting diode display device, etc. Moreover, while not required, each of the units 410, 420, 430, 440, 450, 470 can be one or more processors or processing elements on one or more chips or integrated circuits.

The video data decoder 410 reads video data received from a disc (such as a DVD, a Blu-ray disc, etc.), the local storage 480, and/or an external storage device (such as a flash memory, an external hard disk drive, a computer, etc.), and decodes the video data. The meta data analyzer 420 reads the meta data 100 with respect to the video data from the disc, the local storage 480, and/or the external storage device, and analyzes the meta data 100. The video data and the meta data 100 with respect to the video data may be stored in the server 200 or recorded on the disc or the external storage device in a multiplexed or independent manner. Furthermore, it is understood that the image processing apparatus 400 need not receive the video data and the meta data from a same source in all aspects of the present invention. For example, in some aspects, the image processing apparatus 400 may download the video data from the server 200 and read the meta data 100 with respect to the video data from the disc. Also, the image processing apparatus 400 may read the video data from the disc, and download the meta data 100 with respect to the video data from the server 200. Moreover, while not required, the image processing apparatus 400 can include a drive to read the disc directly, or can be connected to a separate drive.

When the video data and/or the meta data 100 with respect to the video data are stored in the server 200, the image processing apparatus 400 may download the video data and/or the meta data 100 with respect to the video data from the server 200 through the communication network 300 and use the video data and/or the meta data 100. The server 200 may be operated by a content provider such as a broadcasting station or a general content producer, and stores the video data and/or the meta data 100 with respect to the video data. The server 200 extracts contents requested by a user and provides the contents to the user.

The communication unit 470 requests the server 200 to provide the video data and/or the meta data 100 with respect to the video data, which are desired by the user, through the wired or wireless communication network 300 and receives the video data and/or the meta data 100 with respect to the video data from the server 200. When the communication unit 470 uses a wireless communication technique, the communication unit 470 may include a radio signal transceiver (not shown), a baseband processor (not shown), and/or a link controller (not shown). The wireless communication technique may be a WLAN, Bluetooth, Zigbee, Wibro, etc.

The local storage 480 stores information downloaded by the communication unit 470 from the server 200, or read from the disc or external storage device. In the shown embodiment, the local storage 480 stores the video data and/or the meta data 100 with respect to the video data received from the server 200 through the communication unit 470, though it is understood that all embodiments are not limited thereto. For example, as described above, the video data and/or the meta data may be received from a disc or an external storage device. Furthermore, the video data and/or the meta data need not be stored in the local storage in all embodiments.

If the video data and/or the meta data 100 with respect to the video data are recorded on the disc in a multiplexed or independent manner, when the disc is loaded in the image processing apparatus 400, the video data decoder 410 and the meta data analyzer 420 respectively read the video data and the meta data 100 from the disc. The meta data 100 may be recorded in a lead-in region, a user data region, and/or a lead-out region of the disc. When the video data is recorded on the disc, the data is read by a drive (not shown), and the meta data analyzer 420 extracts, from the read meta data 100, a disc identifier to identify the disc on which the video data is recorded and a title identifier representing which title on the disc corresponds to the video data. Accordingly, the meta data analyzer 420 determines which video data the meta data 100 is associated with, using the disc identifier and the title identifier.

The meta data analyzer 420 detects an output duration of frames including an object from the meta data 100. When an output point in time of a current frame is included in the output duration of the frames including the object, the meta data analyzer 420 parses background depth information and object depth information about the current frame from the meta data 100 and sends the parsed background depth information and the object depth information to the depth map generator 440.

The mask buffer 430 temporarily stores a mask to be applied to a currently output frame, when information on the mask is defined as object region information for an object included in the currently output frame. The mask may be constructed in such a manner that a portion corresponding to the object has a color different from that of other portions, or the mask may be perforated along the shape of the object.

The depth map generator 440 generates a depth map for a frame using the background depth information and the object depth information received from the meta data analyzer 420 and/or the mask received from the mask buffer 430. The depth map generator 440 respectively generates a depth map for a background and a depth map for an object and combines the two depth maps to create a depth map for a single frame. Specifically, the depth map generator 440 identifies the region of the object using object region information included in the object depth information. The depth map generator 440 ascertains the shape of the object using coordinates or the mask and gives depth values to the ascertained object.

In particular, if the object is a normal object (i.e., contacts the background) and the object region information represents the region of the object as coordinates, the depth map generator 440 obtains coordinates of the background identical to coordinates representing the region of the normal object (i.e., coordinates of positions where the normal object meets the background), and creates the depth map for the normal object by using depth values corresponding to the obtained coordinates of the background as depth values for the normal object. In contrast, if the object is a normal object and the object region information represents the region of the object as a mask on which the shape of the object is indicated, the depth map generator 440 extracts information representing which coordinates among the coordinates of the background are identical with the coordinates representing the region of the normal object (i.e., reference information) from the object depth information and creates the depth map for the normal object by using a depth value of the background corresponding to a coordinate of a position where the normal object touches the background as the depth value for the normal object. The coordinate of the position where the normal object touches the background is ascertained using the reference information.

If the object is a highlighted object, the depth map generator 440 creates a depth map for the highlighted object by using, as the depth value of the region of the highlighted object identified from the object region information, a value obtained using an offset value included in the object depth information and a panel position value.

The depth map generator 440 generates the depth map for the single frame including the object and the background by using the generated depth map for the background and the generated depth map for the object. The depth map generator 440 sends the generated depth map to the stereo rendering unit 450.

The stereo rendering unit 450 generates a left-eye image and a right-eye image using the video image received from the video data decoder 410 and the depth map received from the depth map generator 440 and creates an image in a 3D format including both the left-eye image and the right-eye image. Examples of the 3D format include a top-and-down format, a side-by-side format, an interlaced format, etc. The stereo rendering unit 450 transmits the 3D formatted image to the output unit 460. However, it is understood that embodiments of the present invention are not limited thereto. For example, in other embodiments, the output unit 460 is not included in the image processing apparatus 460 and/or the image processing apparatus 400 outputs the 3D formatted image to another computing device or to an external output device.

The output unit 460 sequentially displays the left-eye image and the right-eye image on a screen of a display device. A viewer recognizes an image to be continuously played without cease when the image is displayed at a frame rate of at least 60 Hz on the basis of one eye of the viewer. Thus, the display device displays the image at a frame rate of at least 120 Hz such that images input through left and right eyes are combined and recognized as a 3D image. The output unit 460 sequentially displays left and right images included in a frame at least every 1/120 seconds.

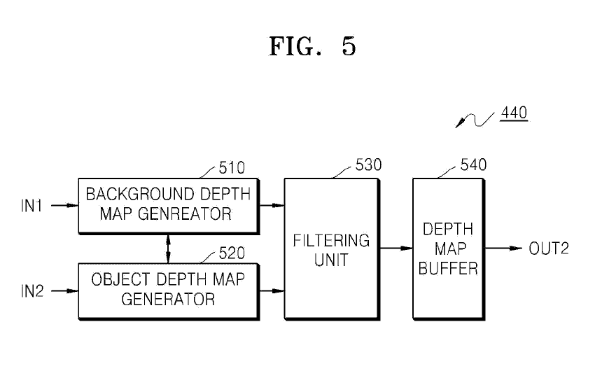

FIG. 5 is a block diagram of the depth map generator 440 illustrated in FIG. 4. Referring to FIG. 5, the depth map generator 440 includes a background depth map generator 510, an object depth map generator 520, a filtering unit 530, and a depth map buffer 540. The background depth map generator 510 receives coordinate values of the background, background depth values corresponding to the coordinate values, and a panel position value, which are included in the background depth information, from the meta data analyzer 420 illustrated in FIG. 4. Accordingly, the background depth map generator 510 creates the depth map for the background using the background coordinate values, the background depth values corresponding to the background coordinate values, and the panel position value. The background depth map generator 510 sends the generated depth map for the background to the filtering unit 530.

The object depth map generator 520 receives object region information, which is included in the object depth information, from the meta data analyzer 420 illustrated in FIG. 4 and creates the depth map for the object using the object region information. When the object region information corresponds to a mask, the object depth map generator 520 receives a mask to be applied to the corresponding frame from the mask buffer 430 and identifies a region of the object by using the mask. When the object is a normal object, the object depth map generator 520 requests the background depth map generator 510 to provide background depth values corresponding to coordinates at which the object and the background meet. The object depth map generator 520 receives the background depth values corresponding to the coordinates of positions on the background touched by the object from the background depth map generator 510 and creates the depth map for the object by using the background depth values. When the object is a highlighted object, the object depth map generator 520 identifies a region of the highlighted object using the object region information included in the object depth information. Accordingly, the object depth map generator 520 generates a depth map for the highlighted object by using, as the depth value of the region of the highlighted object, a value obtained using an offset value included in the object depth information and the panel position value. The object depth map generator 520 sends the depth map for the object to the filtering unit 530.

When the meta data 100 includes effect information, the filtering unit 530 selects a depth map to be applied to the depth map for the background and/or the depth map for the object by using the effect information included in the meta data 100. Accordingly, the filtering unit 530 modifies the depth map for the background and/or the depth map for the object using the selected depth map in order to control the depth map for the background and/or the depth map for the object so that the background and/or the object has a stereoscopic depth. This operation is referred to as filtering. The depth map for the object has depth values parallel with an image plane, and thus the filtering unit 530 may apply a filter to the object in order to give a stereoscopic effect to the object having the depth values parallel with the image plane. When the depth map for the background is a plane (for example, when all the background depth values are panel position values), the filtering unit 530 may also apply a filter to the background to give the background a stereoscopic effect.

The depth map buffer 540 temporarily stores the depth map for the background, which has passed through the filtering unit 530, and adds the depth map for the object to the depth map for the background when the depth map for the object is created, thereby updating the depth map for the frame. When there are multiple objects, the depth map buffer 540 sequentially adds depth maps for the multiple objects to the depth map for the background to update the depth map for the frame. When the depth map is completed, the depth map buffer 540 transmits the generated depth map to the stereo rendering unit 450 of FIG. 4.

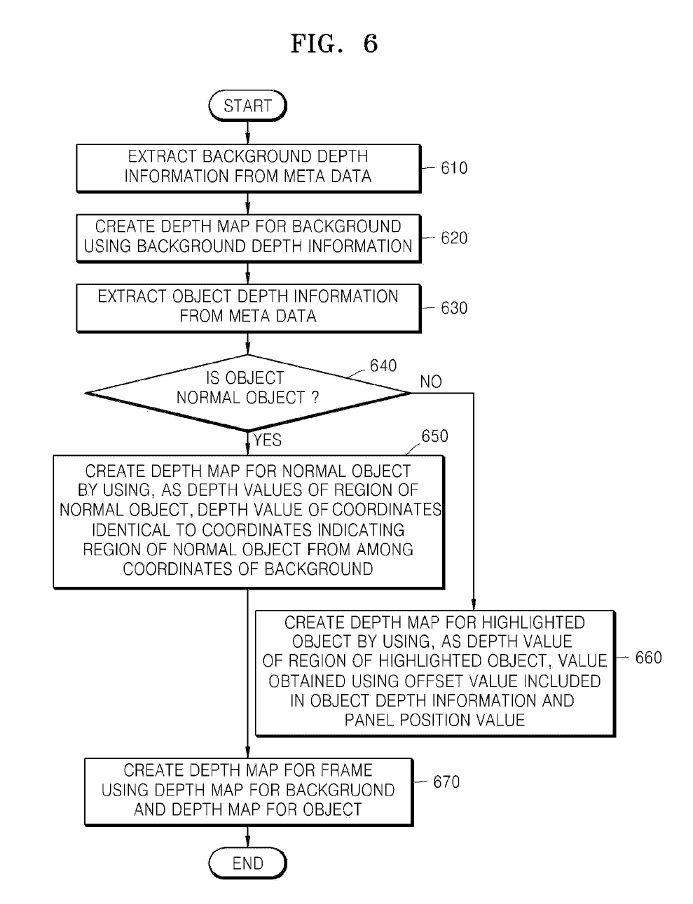

FIG. 6 is a flowchart illustrating a depth map generating method according to an embodiment of the present invention. Referring to FIG. 6, the image processing apparatus 400 illustrated in FIG. 4 extracts background depth information to be applied to a current frame from the meta data 100 with respect to video data when the current frame is classified into a new shot, in operation 610. Specifically, the image processing apparatus 400 extracts coordinate values of a background, depth values corresponding to the coordinate values, and a panel position value from the background depth information. Accordingly, the image processing apparatus 400 generates a depth map for the background using the coordinate values of the background, the depth values, and the panel position value in operation 620.

The image processing apparatus 400 extracts object depth information from the meta data 100 in operation 630. The object depth information includes an object output time and object region information. If it is determined based on the object output time that the current frame includes an object, it is determined whether the object is a normal object or a highlighted object, in operation 640. If the object is a normal object, the image processing apparatus 400 identifies a region of the normal object using the object region information included in the object depth information. Moreover, the image processing apparatus 400 creates a depth map for the object by setting the depth values of coordinates identical to the coordinates representing the region of the normal object from among the background coordinates included in the background depth information to be the depth values for the normal object, in operation 650.

If the object is a highlighted object, the image processing apparatus 400 identifies a region of the highlighted object using the object region information included in the object depth information. Accordingly, the image processing apparatus 400 creates a depth map for the highlighted object by using, as the depth value of the region of the highlighted object, a value obtained using an offset value included in the object depth information and the panel position value, in operation 660. The image processing apparatus 400 creates a depth map for the frame by using the depth map for the background and the depth map for the object in operation 670.

While not restricted thereto, aspects of the present invention can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet. Moreover, while not required in all aspects, one or more units of the image processing apparatus 400 can include a processor or microprocessor executing a computer program stored in a computer-readable medium, such as the local storage 480.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An image processing method of an image processing apparatus, the image processing method comprising:
extracting background depth information and object depth information from meta data with respect to video data;
creating, by the image processing apparatus, a depth map for a background of a frame of the video data using the extracted background depth information; and
creating, by the image processing apparatus, a depth map for an object of the frame of the video data using the extracted object depth information,
wherein the object depth information distinguishes between when the object is a normal object that contacts the background and a highlighted object that does not contact the background.

2. The image processing method as claimed in claim 1, wherein:
the creating of the depth map for the object comprises extracting object region information to identify a region of the object in the frame from the extracted object depth information; and
the object region information comprises coordinates to identify the region of the object, a mask on which a shape of the object is indicated, and/or color information of the object to distinguish the object from the background.

3. The image processing method as claimed in claim 2, wherein:
the creating of the depth map for the background comprises creating the depth map for the background using coordinates of the background, depth values of the background corresponding to the coordinates, and a panel position value representing a depth value of an output screen for the video data; and
the background depth information comprises the coordinates of the background, the depth values of the background, and the panel position value.

4. The image processing method as claimed in claim 3, wherein the creating of the depth map for the object further comprises:
when the object is the normal object and the object region information comprises the coordinates to identify the region of the object, detecting coordinates identical to the coordinates indicating the region of the normal object from among the coordinates of the background; and
creating the depth map for the normal object using the background depth values corresponding to the detected coordinates as depth values for the region of the normal object.

5. The image processing method as claimed in claim 3, wherein the creating of the depth map for the object further comprises:
when the object is the normal object and the object region information is the mask on which the shape of the object is indicated, extracting reference information representing coordinates identical to the coordinates indicating the region of the normal object from among the coordinates of the background, from the object depth information; and
creating the depth map for the normal object using the background depth values corresponding to the identical coordinates as depth values for the region of the normal object, using the reference information.

6. The image processing method as claimed in claim 3, wherein the creating of the depth map for the object further comprises, when the object is the highlighted object, creating the depth map for the highlighted object using, as a depth value of the region of the highlighted object, a value obtained using an offset value included in the object depth information and the panel position value of the background depth information.

7. The image processing method as claimed in claim 6, wherein the creating of the depth map for the highlighted object comprises obtaining the value by adding or subtracting the offset value to/from the panel position value.

8. The image processing method as claimed in claim 6, wherein:
the creating of the depth map for the object further comprises, if the object is the highlighted object, adjusting the depth map for the highlighted object by applying a predetermined depth map to the region of the highlighted object; and
the object depth information comprises effect information indicating the predetermined depth map.

9. The image processing method as claimed in claim 1, further comprising determining, based on shot information included in the meta data to classify frames of the video data into units of shots, whether the frame is classified into a new shot not previously processed,
wherein the extracting of the background depth information comprises:
when the frame is classified into the new shot, extracting the background depth information to be applied to the frame classified into the new shot, and
when the frame is not classified into the new shot, using previously extracted background depth information and/or a previously created depth map for the background to be applied to the frame.

10. The image processing method as claimed in claim 9, wherein:
the shot information comprises output time information of an initially output frame from among frames classified into a single shot and/or output time information of a finally output frame from among the frames; and
the determining of whether the frame is classified into the new shot comprises determining, based on the output time information of the initially output frame and/or the output time information of the finally output frame, whether the frame is classified into the new shot.

11. The image processing method as claimed in claim 10, further comprising extracting information on an output period of time of frames including the normal object from among frames classified into a current shot, into which the frame is classified, from the meta data.

12. The image processing method as claimed in claim 1, further comprising reading the meta data from a disc on which the video data is recorded or downloading the meta data from a server via a communication network.

13. The image processing method as claimed in claim 1, wherein the meta data comprises identification information to identify the video data, and the identification information comprises a disc identifier to identify a disc on which the video data is recorded and a title identifier to identify a title including the video data from among titles included in the disc.

14. The image processing apparatus as claimed in claim 2, wherein the creating of the depth map for the object further comprises:
when the object is the normal object, detecting coordinates identical to the coordinates indicating the region of the normal object from among coordinates of the background, and creating the depth map for the normal object using background depth values corresponding to the detected coordinates as depth values for the region of the normal object; and
when the object is the highlighted object, creating the depth map for the highlighted object using, as a depth value of the region of the highlighted object, a value obtained using an offset value included in the object depth information and a panel position value included in the meta data to represent a depth value of an output screen for the video data.

15. The image processing apparatus as claimed in claim 1, wherein the meta data comprises information to indicate whether the object is the normal object or the highlighted object.

16. An image processing apparatus comprising:
a meta data analyzer to extract background depth information and object depth information from meta data with respect to video data and to analyze the meta data; and
a depth map generator to create a depth map for a background of a frame of the video data using the extracted background depth information and to create a depth map for an object of the frame of the video data using the extracted object depth information,
wherein the object depth information distinguishes between when the object is a normal object that contacts the background and a highlighted object that does not contact the background.

17. The image processing apparatus as claimed in claim 16, wherein:
the depth map generator extracts object region information to identify a region of the object in the frame from the extracted object depth information; and
the object region information comprises coordinates to identify the region of the object, a mask on which a shape of the object is indicated, and/or color information of the object to distinguish the object from the background.

18. The image processing apparatus as claimed in claim 17, wherein:
the depth map generator creates the depth map for the background using coordinates of the background, depth values of the background corresponding to the coordinates, and a panel position value representing a depth value of an output screen for the video data; and
the background depth information comprises the coordinates of the background, the depth values of the background, and the panel position value.

19. The image processing apparatus as claimed in claim 18, wherein, when the object is the normal object and the object region information comprises the coordinates to identify the region of the object, the depth map generator obtains coordinates identical to the coordinates indicating the region of the normal object from among the coordinates of the background and creates the depth map for the normal object using the background depth values corresponding to the obtained coordinates as depth values for the region of the normal object.

20. The image processing apparatus as claimed in claim 18, wherein, when the object is the normal object and the object region information is the mask on which the shape of the object is indicated, the depth map generator extracts reference information representing coordinates identical to the coordinates indicating the region of the normal object from among the coordinates of the background, from the object depth information, and creates the depth map for the normal object using the background depth values corresponding to the identical coordinates as depth values for the region of the normal object, using the reference information.

21. The image processing apparatus as claimed in claim 18, wherein, when the object is the highlighted object, the depth map generator creates the depth map for the highlighted object using, as a depth value of the region of the highlighted object, a value obtained using an offset value included in the object depth information and the panel position value of the background depth information.

22. The image processing apparatus as claimed in claim 21, wherein the depth map generator obtains the value by adding or subtracting the offset value to/from the panel position value.

23. The image processing apparatus as claimed in claim 21, wherein:
when the object is the highlighted object, the depth map generator adjusts the depth map for the highlighted object by applying a predetermined depth map to the region of the highlighted object; and
the object depth information comprises effect information indicating the predetermined depth map.

24. The image processing apparatus as claimed in claim 16, wherein:
the meta data comprises shot information to classify frames of the video data into units of shots;
the meta data analyzer determines, based on the shot information, whether the frame is classified into a new shot not previously processed;
when the frame is classified into the new shot, the depth map generator generates the depth map for the object using the background depth information to be applied to the frame classified into the new shot; and
when the frame is not classified into the new shot, the depth map generator uses previously extracted background depth information and/or a previously created depth map for the background to be applied to the frame.

25. The image processing apparatus as claimed in claim 24, wherein:
the shot information comprises output time information of an initially output frame from among frames classified into a single shot and/or output time information of a finally output frame from among the frames; and
the meta data analyzer determines, based on the output time information of the initially output frame and/or the output time information of the finally output frame, whether the frame is classified into the new shot.

26. The image processing apparatus as claimed in claim 25, wherein the meta data analyzer extracts information on an output period of time of frames including the normal object from among frames classified into a current shot, into which the frame is classified, from the shot information.

27. The image processing apparatus as claimed in claim 16, wherein the meta data is read from a disc on which the video data is recorded or downloaded from a server via a communication network.

28. The image processing apparatus as claimed in claim 16, wherein the meta data comprises identification information to identify the video data, and the identification information comprises a disc identifier to identify a disc on which the video data is recorded and a title identifier to identify a title including the video data from among titles included in the disc.

29. The image processing apparatus as claimed in claim 17, wherein:
when the object is the normal object, the depth map generator obtains coordinates identical to the coordinates indicating the region of the normal object from among coordinates of the background and creates the depth map for the normal object using background depth values corresponding to the obtained coordinates as depth values for the region of the normal object; and
when the object is the highlighted object, the depth map generator creates the depth map for the highlighted object using, as a depth value of the region of the highlighted object, a value obtained using an offset value included in the object depth information and a panel position value included in the meta data to represent a depth value of an output screen for the video data.

30. The image processing apparatus as claimed in claim 16, wherein the meta data comprises information to indicate whether the object is the normal object or the highlighted object.

31. A computer readable information storage medium for use with an image processing apparatus, the computer-readable information storage medium comprising:
meta data used by the image processing apparatus to convert video data into a three-dimensional (3D) image, wherein:
the meta data comprises background depth information and object depth information;
the background depth information comprises coordinates of a background of a frame of the video data, depth values of the background corresponding to the coordinates, and a panel position value representing a depth value of an output screen for the video data;
the object depth information represents a region of an object on the frame as coordinates or a mask on which a shape of the object is indicated;
the background depth information and the object depth information are respectively used by the image processing apparatus to generate a depth map for the background and a depth map for the object; and
the object depth information indicates to the image processing apparatus when the object is a normal object that contacts the background or a highlighted object that does not contact the background.

32. A computer readable information storage medium storing a program to execute the image processing method of claim 1 and implemented by an image processing apparatus.

33. A meta data transmitting method performed in a server connected to an image processing apparatus, the method comprising:
receiving, by the server, a request for meta data to convert video data into a three-dimensional (3D) image from the image processing apparatus; and
transmitting, by the server, the meta data to the image processing apparatus in response to the request, wherein:
the meta data comprises background depth information and object depth information;
the background depth information comprises coordinates of a background of a frame of the video data, depth values of the background corresponding to the coordinates, and a panel position value representing a depth value of an output screen for the video data;
the object depth information comprises coordinates to identify a region of an object of the frame of the video data or a mask on which a shape of the object is indicated; and
the object depth information distinguishes between when the object is a normal object that contacts the background or a highlighted object that does not contact the background.

34. A server connected to an image processing apparatus, the server comprising:
a transceiver to receive a request for meta data to convert video data into a three-dimensional (3D) image from the image processing apparatus, and to transmit the meta data to the image processing apparatus in response to the request; and
a meta data storage to store the meta data, wherein:
the meta data comprises background depth information and object depth information;
the background depth information comprises coordinates of a background of a frame of the video data, depth values of the background corresponding to the coordinates, and a panel position value representing a depth value of an output screen for the video data;
the object depth information comprises coordinates to identify a region of an object of the frame of the video data or a mask on which a shape of the object is indicated; and
the object depth information distinguishes between when the object is a normal object that contacts the background or a highlighted object that does not contact the background.
